(19) United States
(12) Patent Application Publication
(10) Pub. No.: US 2017/0202034 A1
(43) Pub. Date: Jul. 13, 2017

(54) SYSTEM AND METHOD OF ESTABLISHING A CONNECTION TO A WIRELESS LOCAL AREA NETWORK THROUGH A PERSONAL AREA NETWORK CONNECTION

(71) Applicants: Garry Paxinos, Pompano Beach, FL (US); Anastasios Kyriakides, Hollywood, FL (US); Anastasios Nicholas Kyriakides, II, Plantation, FL (US); Kenneth Hosfeld, Coral Springs, FL (US); Alain Gonzalez, Miami, FL (US)

(72) Inventors: Garry Paxinos, Pompano Beach, FL (US); Anastasios Kyriakides, Hollywood, FL (US); Anastasios Nicholas Kyriakides, II, Plantation, FL (US); Kenneth Hosfeld, Coral Springs, FL (US); Alain Gonzalez, Miami, FL (US)

(21) Appl. No.: 15/384,292

(22) Filed: Dec. 19, 2016

Related U.S. Application Data
(60) Provisional application No. 62/269,881, filed on Dec. 18, 2015.

(51) Int. Cl. H04W 76/02; H04W 4/00; H04W 12/06

(52) U.S. Cl. CPC H04W 76/02; H04W 12/06; H04W 4/008; H04W 84/12

(57) ABSTRACT

A method for establishing a connection to a wireless local area network connection through an access point on a target device having a limited user interface through a wireless personal area network connection between the target device and a controlling device with a superior user interface, such as a smart phone. The process of establishing a connection begins with the creation of a wireless personal area network connection bond between the target device and the controlling device. One the bond is created, the configuration and authentication information required to connect to the access point is provided to the target device from the controlling device. Following the provision of the authentication information, the target device then establishes the desired connection to the access point with the authentication information.

### CROSS REFERENCE TO RELATED APPLICATIONS

This application claims the benefit of and incorporates by reference co-pending U.S. provisional patent application Ser. No. 62/269,881 filed Dec. 18, 2015.

### BACKGROUND OF THE INVENTION

Field of the Invention

This invention relates generally to establishing network connections and, more particularly, to a system and method of establishing a connection to a first wireless network through a second wireless network having a smaller spatial scope.

Description of the Prior Art

The use and design of both wireless local area networks (“WLAN,” such as a WiFi network) to allow electronic devices to connect to computer networks wirelessly and personal area networks to, in many cases, directly exchange data over short distances wirelessly is well known. Connections to a WLAN network are often established through a wireless access point, which is generally connected to or integral with a network connected router. Such an access point typically provide for wireless connections using radio frequency links that allow other devices to utilize its connection with the integrated router. On the other hand, personal area networks (“PAN”) connections, such as Bluetooth, Zigbee, Z-Wave, LOWPAN, generally define wire-replacement communications protocols that enable control and communication between two or more electronic devices.

Both WLAN connections through an access point and PAN connections between devices require an initial set up or configuration when first established. For WLAN connections, the set up typically involves the selection of an access point/network to connect to and the provision of configuration and authentication information. In many cases, it is contemplated that WLAN connections will be made on devices with a manual input interface and a visual output interface. As such, the selection of a network and the provision of configuration and authentication information on such modern devices generally requires the use of both of these interfaces (which may be combined, as in a touch screen) on the device that is attempting to connect to the target network.

In other cases, there are devices that require arcane mechanisms to setup the WLAN. For example, on some WLAN enabled analog telephone adapters, a user must first connect the adapter to a wired network, ascertain the Internet Protocol address to which it is connected, and then access from another computer a webpage to complete the setup of the adapter's WLAN interface (this is alternatively accomplished in some instances through an app running on a smartphone connected to a network that, once the adapter is connected by wire to the network, can find the adapter on the network and configure it).

For PAN connections, such as a Bluetooth connection, discrete devices are generally configured to communicate wirelessly through bonding. A bond between discrete devices is formed through the process of pairing, which is triggered either by specific user action or automatically upon the commencement of a device's use (which may include near field communication actions and/or tapping the devices together). While some user interaction is required during the pairing process, there exist conventional protocols that allow for the formation of a bond with a limited input and/or output device, such as just works pairing, legacy fixed pin pairing, numeric comparison, passkey entry, and out of band.

Nonetheless, a problem which still exists is that the options for connecting a limited input and/or output device to a WLAN are generally very limited. Thus, there remains a need for a system and method of establishing a connection to a WLAN through a PAN connection.

The Applicant's invention described herein provides for a system and method for connecting a target device to a WLAN using a discrete controlling device that is connected to the target device through a PAN. When in operation, the system and method enables a user to connect a limited input and/or output device to an access point and establish a WLAN network connection with information provided on a discrete device that is wirelessly connected to the limited input and/or output device. As a result, many of the limitations imposed by prior art systems are removed.

### SUMMARY OF THE INVENTION

A method for establishing a connection to a wireless local area network connection through an access point on a target device having a limited user interface through a wireless personal area network connection between the target device and a controlling device with a superior user interface, such as a smart phone. The process of establishing a connection begins with the creation of a wireless personal area network connection bond between the target device and the controlling device. One the bond is created, the authentication information required to connect to the access point is provided to the target device from the controlling device. Advantageously, because of the bond, the user interfaces on the controlling device can be used to deliver the authentication information into the target device. Following the provision of the authentication information, the target device then establishes the desired connection to the access point with the authentication information. Again because of the bond, in some cases the user interfaces on the controlling device can be used to initiate, confirm, and test the target device's connection to the access point. Significantly, once the target device's connection to the access point is established, the controlling device is no longer necessary to maintain the target device's connection to the access point or otherwise access the network wirelessly therethrough.

It is an object of this invention to provide a system and method of establishing a connection to a WLAN through a PAN connection.

This and other objects will be apparent to one of skill in the art.

### BRIEF DESCRIPTION OF THE DRAWINGS

FIG. 1 shows the components of a system for establishing a connection to a WiFi network on a target limited input and/or output device having through a PAN connection in accordance with the present invention.

FIG. 2 shows a process for establishing a WiFi connection on a target device through the provision of configuration and authentication data from a discrete controlling device that is connected to the target device through a PAN.

### DETAILED DESCRIPTION OF THE INVENTION

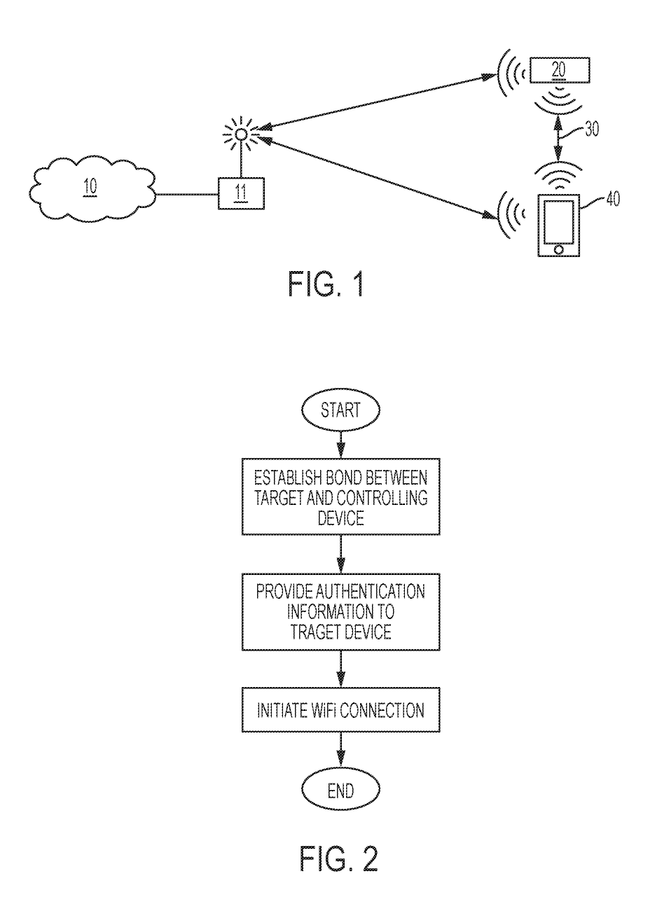

Referring now to the drawings and in particular FIGS. 1 and 2, a system for establishing a connection to a network 10 (such as the Internet) connected WiFi access point 11 on a target device 20 employs a Bluetooth (or other PAN) connection 30 between the target device 20 and a controlling device 40. It is appreciated that the target device 20 in accordance with the present invention may define an electronic device having wireless networking functionality (and PAN functionality) and a limited input and/or output interface. For example, the target device may define a conventional analog telephone adapter (“ATA”), utility devices such as lights, switches, lawn sprinkler controllers, or an electronic accessory device such as a wireless speaker or WiFi video projector. It is contemplated that the controlling device 40 may define any conventional wireless device that includes a manual input interface and a visual output interface that can be used to control the communication of data on the controlling device 40. For example, in one embodiment, the controlling device may define a smart phone, tablet, laptop/personal computer, or other computing capable device. It is contemplated that the controlling device 40 is caused to perform the steps of the instant method through instructions contained in software application(s) run by a processor in the controlling device 40

The process of connecting a target device 20 begins with the bonding of the target device 20 with a controlling device 40. It is contemplated that conventional pairing triggering protocols, such as dedicated bonding or general bonding, may be employed to initiate such bonding and that known mechanisms for creating and/or sharing a link key may be employed to establish the bond between devices. Once bonded, the input and output interfaces on the controlling device 40 are employed to provide the authentication information necessary to access the access point 11 to the target device 20. In some instances, the input and output interfaces on the controlling device 40 may also be required to identify the access point 11 to which the target device 20 is to connect.

In one embodiment, the authentication information is provided through the entry of text on the controlling device 40 that is then transmitted to the target device 20. In another embodiment, the authentication information is provided through a data file stored on the controlling device 40 that contains the authentication information (as used by the controlling device 40 to access the access point 11 or otherwise) being transmitted to the target device 20, essentially allowing the controlling device 40 to share its connection settings with the target device 10. Accordingly, it is contemplated that the controlling device 40 may additionally be configured to create a data file which details its connection settings with the target device 10 by way of a software application of a function therein.

Typically, following the provision of the authentication information, the user interfaces on the controlling device 40 are used to initiate the target device's 20 connection to the access point 11. The step of initiation defines causing the hardware and software WiFi components on the target device 20 to attempt to connect to the access point using the authentication information provided by the controlling device 40. In some cases, however, receipt of authentication information the target device 20 may cause the target device 20 to automatically attempt to connect to the access point.

Once the target device's 20 connection to the access point 11, it is contemplated that the controlling device 40 is no longer necessary to maintain the target device's connection to the access point 11 or otherwise access the network 10 wirelessly therethrough.

In one embodiment, the connection established may be subsequently verified and tested through the controlling device 40. In one instance, this may be done by transmitting data to the target device 20 by way of the target device's 20 connection to the access point 11.

It is appreciated that the method of establishing a connection to a network 10 connected WiFi access point 11 on a target device 20 may be advantageously employed in scenarios wherein a target device 20 is not manufactured with the type of user interfaces that make establishing a wireless network connection straightforward. This could be because it is impractical or undesirable to build such capabilities in or even when the built in protocols fail to provide sufficient security in their customary operation.

In an exemplary scenario, an ATA device that uses WiFi but does not have any display may define a target device 20. By connecting to the ATA using a phone or tablet (as a controlling device) with a screen and input using a Bluetooth connection, one can configure the Wifi settings and have the ATA then connect to the WiFi. The connection can then be verified and tested while still using the phone or tablet. Additionally, if the authentication information is provided through a data file containing the authentication information as used by the controlling device 40, the WiFi settings of the controlling device can be used to more easily configure the WiFi on the target device.

An exemplary WiFi connection process would begin with using a smart phone in Bluetooth discovery mode, pair the phone with the ATA, followed by a user starting a custom app on the smart phone from the ATA's manufacturer or service provider, followed by the ATA reporting to the smart phone the WiFi networks (SSID) it can hear, followed by the custom app on the smart phone determining whether it has credentials for the SSID(s) reported by the ATA and then sending the configuration information to the ATA over the Bluetooth connection. In a situation wherein both the smart phone and ATA show multiple SSIDs, the customer is asked to choose which one to configure through the interface of the smart phone. In a situation wherein there are no SSIDs in common between the smart phone and ATA, the user is asked through the interface of the smart phone to enter the relevant information (e.g., SSID, security type, password).

It is appreciated that while the instant invention has been illustrated in association with a WiFi network (as a type of WLAN), any suitable WLAN may be employed in the alternative to a WiFi WLAN. Furthermore, while the instant invention has been illustrated in association with a WLAN, it is contemplated that other network types having a different spatial scope, such as a wide area network or metropolitan area network, may be connected to in the same manner.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A method of establishing a wireless network connection on a target device through the provision of data from a controlling device, comprising the steps of:
establishing a networking connection between a controlling device and a target device such that said controlling device can communicate electrical signals with said target device directly, wherein said target device includes a first wireless network interface;
providing by said controlling device at least one of configuration and authentication information required to wirelessly connect to a wireless area network base station defining an access point to the target device over the connection established between the he controlling device and target device; and
initiating a wireless connection between the first wireless network interface of the target device and the base station using the at least one of configuration and authentication information transmitted to the target device from the controlling device.

2. The method of claim 1, wherein the controlling device includes a wireless network interface, the target device includes a second wireless network interface, and the controlling device and the target device are connected wirelessly by way of the wireless network interface of the controlling device and the second wireless network interface of the target device.

3. The method of claim 2, wherein the controlling device is connected to said target device through a wireless personal area network connection.

4. The method of claim 3, wherein the step of establishing includes pairing the controlling device and the target device so as to establishing bond over the wireless personal area network between the controlling device and the target device.

5. The method of claim 1, wherein the step of initiating is performed automatically by the target device once the at least one of configuration and authentication information is provided by the controlling device.

6. The method of claim 1, wherein the step of initiating is performed by the target device in response to a separate command from the controlling device.

7. A method of establishing a wireless network connection on a target device through the provision of data from a controlling device, comprising the steps of:
providing a controlling device having at least a wireless network interface, a memory, a manual input interface and a visual output interface;
providing a target device having at least a first wireless network interface and a second wireless network interface;
establishing a networking connection between the controlling device and the target device, wherein the controlling device and the target device are connected wirelessly by way of the wireless network interface of the controlling device and the second wireless network interface of the target device such that said controlling device can communicate electrical signals with said target device directly;
providing by said controlling device at least one of configuration and authentication information required to wirelessly connect to a wireless area network base station defining an access point to the target device over the connection established between the he controlling device and target device; and
initiating a wireless connection between the first wireless network interface of the target device and the base station using the at least one of configuration and authentication information transmitted to the target device from the controlling device.

8. The method of claim 7, wherein the at least one of configuration and authentication information provided to the target device is received by said controlling device through actuation of the manual input interface immediately prior to being provided to the target device.

9. The method of claim 7, wherein the at least one of configuration and authentication information provided to the target device is retrieved from a electronic file stored on said controlling device in the memory immediately prior to being provided to the target device.

10. The method of claim 7, wherein the step of initiating is performed automatically by the target device once the at least one of configuration and authentication information is provided by the controlling device.

11. The method of claim 7, wherein the step of initiating is performed by the target device in response to a separate command from the controlling device.

12. The method of claim 11, wherein the command which causes the step of initiating is generated in response to actuation of the manual input interface on the controlling device.

13. The method of claim 7, wherein the target device defines an analog telephone adapter.
